(19) United States
(12) Patent Application Publication
(10) Pub. No.: US 2004/0054936 A1
(43) Pub. Date: Mar. 18, 2004

(54) Method and apparatus for setting core voltage for a central processing unit

(76) Inventors: Thomas J. Dwyer III, Sunnyvale, CA (US); Han Young Ko, Milpitas, CA (US)

Correspondence Address: PARK, VAUGHAN & FLEMING LLP, 508 SECOND STREET, SUITE 201, DAVIS, CA, 95616, US

(21) Appl. No.: 10/243,288

(22) Filed: Sep. 12, 2002

(51) Int. Cl. G06F 1/26

(52) U.S. Cl. 713/300

(57) ABSTRACT

One embodiment of the present invention provides a system that facilitates setting a core voltage for a central processing unit (CPU) contained within a CPU chip in a computer system. During operation, the system applies an I/O voltage to the CPU chip, thereby enabling I/O buffers within the CPU chip to drive I/O pins on the CPU chip. Next, the system reads a selected set of I/O pins on the CPU chip, wherein the selected set of I/O pins specify an initial core voltage for the CPU. This allows the system to apply the initial core voltage to the CPU chip to enable the CPU to operate. When the CPU is able to operate, the system reads a CPU identifier from the CPU chip, and uses the CPU identifier to lookup an optimal core voltage for the CPU. This allows the system to apply the optimal core voltage to the CPU chip.

### BACKGROUND

1. Field of the Invention

The present invention relates to the design of processors within computer systems. More specifically, the present invention relates to a method and apparatus for setting an optimal core voltage for a central processing unit (CPU) within a computer system.

2. Related Art

Dramatic improvements in computer system performance in recent years have been largely driven by advances in integrated circuit technology. These advances presently make it possible to incorporate hundreds of millions of transistors onto a single processor chip. Unfortunately, these advances have also made processor chips more sensitive to variations in core voltage. Decreasing the core voltage of a processor reduces the amount of heat generated by circuitry within the processor. This makes it possible to integrate larger amounts of circuitry into a processor chip without encountering heat dissipation problems. Moreover, decreasing the core voltage allows circuitry within the processor to switch more rapidly, because smaller voltage swings are required to switch between high voltage levels and low voltage levels. Unfortunately, decreasing core voltage also makes a processor more susceptible to electrical noise, which can greatly reduce reliability of the processor.

Hence, in order to maximize computer system performance, it is necessary to carefully adjust the core voltage to an optimal voltage level. This optimal voltage level is determined by making a tradeoff between reducing core voltage to reduce heat dissipation problems and voltage swings on one hand, and increasing core voltage to minimize noise problems on the other hand.

In existing computer systems core voltage can be set using a number of different techniques. When a processor chip is integrated into a computer system, it is possible to manually configure the core voltage provided by the computer system to match the optimal core voltage for the processor chip. Note that since different types of processor chips typically have different optimal core voltages, each type of processor chip typically requires a different core voltage setting. Unfortunately, this type of manual configuration can be time-consuming, and can increase manufacturing costs. Moreover, manual programming is error-prone because it is possible to program the wrong core voltage for a given processor chip or to inadvertently insert a different processor chip (with a different optimal core voltage) into the computer system.

To avoid these problems within manual configuration, some computer systems presently supply an initial core voltage which allows the processor chip to operate. This allows the computer system to read an identifier fro the processor chip, and this identifier is used to determine the optimal core voltage. One problem with this approach is that a single initial core voltage may not work for all processor chips. Hence, the initial core voltage may not allow the processor chip to operate, or even worse, may cause the processor chip to overheat and be permanently damaged.

What is needed is a method and an apparatus for setting an optimal core voltage for a processor within a computer system without the above-described problems. Note that the terms “processor” and “CPU” (central processing unit) are used interchangeably throughout this specification.

### SUMMARY

One embodiment of the present invention provides a system that facilitates setting a core voltage for a central processing unit (CPU) contained within a CPU chip in a computer system. During operation, the system applies an I/O voltage to the CPU chip, thereby enabling I/O buffers within the CPU chip to drive I/O pins on the CPU chip. Next, the system reads a selected set of I/O pins on the CPU chip, wherein the selected set of I/O pins specify an initial core voltage for the CPU. This allows the system to apply the initial core voltage to the CPU chip to enable the CPU to operate. When the CPU is able to operate, the system reads a CPU identifier from the CPU chip, and uses the CPU identifier to lookup an optimal core voltage for the CPU. This allows the system to apply the optimal core voltage to the CPU chip.

In a variation on this embodiment, the initial core voltage may differ from the optimal core voltage because the initial core voltage is determined through estimation before the CPU chip is manufactured, whereas the optimal core voltage is determined empirically after the CPU chip is manufactured.

In a variation on this embodiment, the selected set of I/O pins is too small to accurately specify the range of possible core voltages for the CPU.

In a variation on this embodiment, reading the CPU identifier involves performing a Joint Test Action Group (JTAG) boundary scan of the CPU chip to read a JTAG identifier for the CPU chip.

In a variation on this embodiment, the operations performed during the core voltage setting process are performed by a system controller which is responsible for initializing voltages for CPUs within the computer system.

In a variation on this embodiment, the operations are performed as part of an initial boot sequence for the computer system.

In a variation on this embodiment, applying the initial core voltage to the CPU involves first programming a voltage regulator for the CPU chip to produce the initial core voltage, and then activating the voltage regulator to supply the initial core voltage to the CPU chip.

### BRIEF DESCRIPTION OF THE FIGURES

FIG. 1 illustrates a computer system in accordance with an embodiment of the present invention.

FIG. 2 illustrates circuitry involved in the voltage setting process in accordance with an embodiment of the present invention.

FIG. 3 presents a flow chart illustrating the process of setting a core voltage in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer System

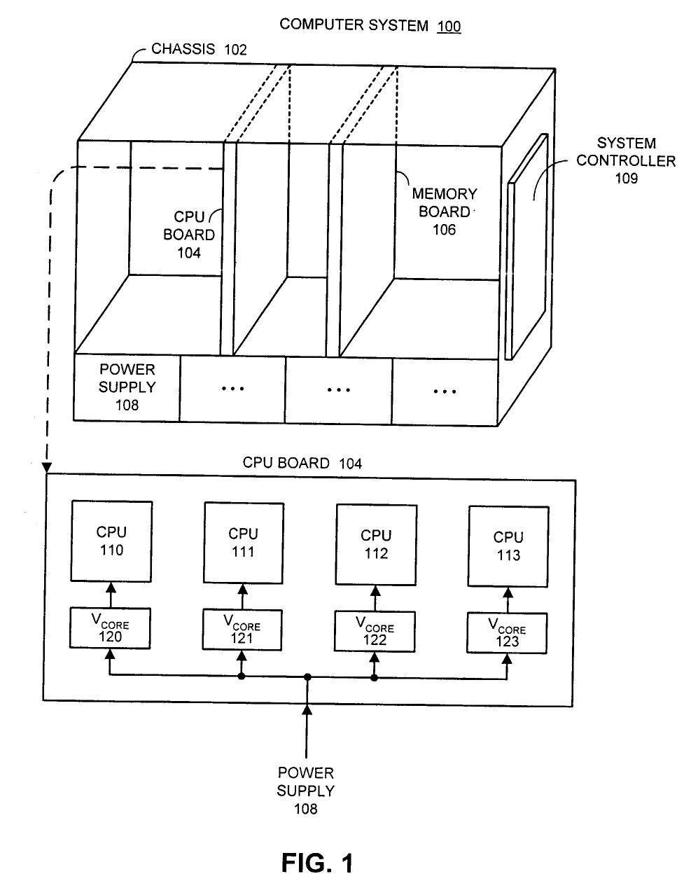

FIG. 1 illustrates a computer system 100 in accordance with an embodiment of the present invention. Computer system 100 can generally include any type of computer system, including, but not limited to, a computer system based on a microprocessor, a mainframe computer, a digital signal processor, a portable computing device, a personal organizer, a device controller, and a computational engine within an appliance. In the embodiment illustrated in FIG. 1. computer system 100 is a large enterprise computer system that includes multiple CPUs.

As is illustrated in FIG. 1, computer system 100 includes a chassis 102 that includes at least one power supply 108, which converts AC power into DC power for use by circuitry within computer system 100. Chassis 102 is designed to house a number of boards containing processors and/or memory. More specifically, chassis 102 can house one or more CPU boards, such as CPU board 104, which contain a number of CPU chips. Chassis 102 can also house one or more memory boards, such as memory board 106.

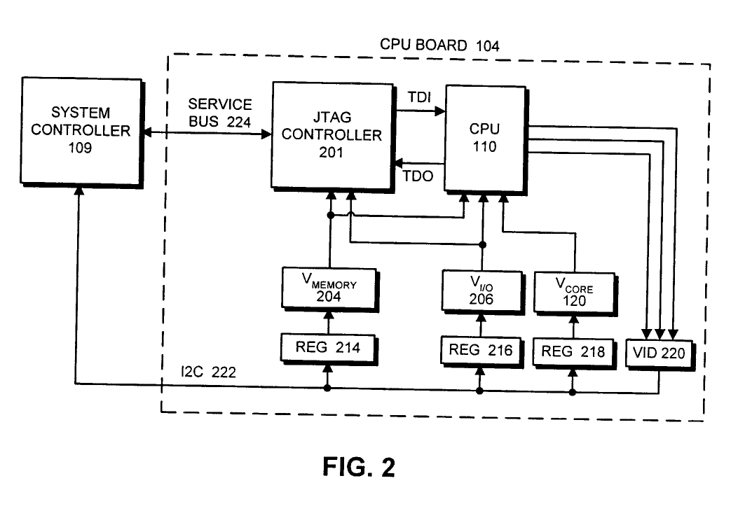

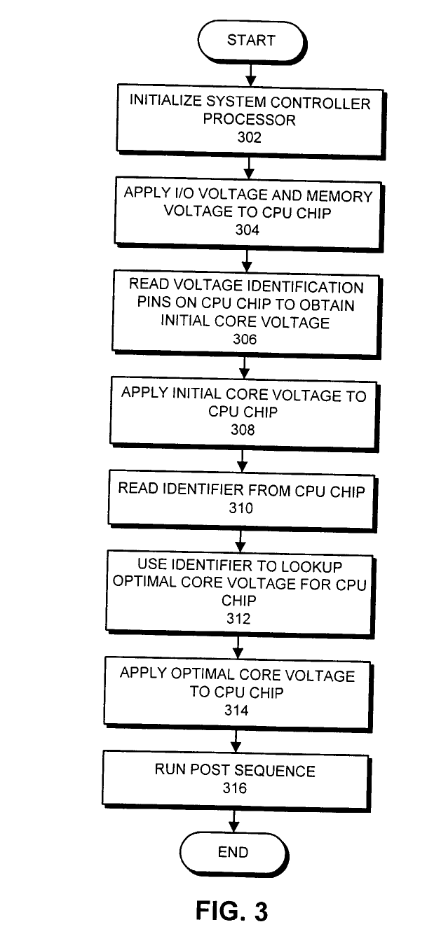

The CPU boards operate under control of system controller 109, which is responsible for initializing the CPU boards. This initialization process involves setting the processor core voltage, as is described in more detail below with reference to FIGS. 2-3.

In one embodiment of the present invention, computer system 100 includes two system controllers for fault-tolerance purposes. In this way, if one of the system controllers fails, the other can take over so that computer system 100 can continue to operate despite the failure.

CPU board 104 is illustrated in more detail in the bottom portion of FIG. 1. Note that CPU board 104 includes four CPU chips 110-113. Each of these CPU chips 110-113 receives core voltage from its own voltage regulator. More specifically, CPU chip 110 receives core voltage from voltage regulator V_{core} 120; CPU chip 111 receives core voltage from voltage regulator V_{core} 121; CPU chip 112 receives core voltage from voltage regulator V_{core} 122; and CPU chip 113 receives core voltage from voltage regulator V_{core} 123. The voltage regulators V_{core} 120-123 receive power from power supply 108 in chassis 102.

Voltage Setting Circuitry

FIG. 2 illustrates circuitry involved in the voltage setting process in accordance with an embodiment of the present invention. As is illustrated in FIG. 2, the voltage setting process operates under control of system controller 109. Although FIG. 1 illustrates this circuitry for only a single CPU chip 110, the circuitry also exists (but is not shown) for the other CPU chips 111-113 on CPU board 104.

System controller 109 initially sets a memory voltage, V_{memory}, and an I/O voltage, V_{I/O}. This is accomplished by writing voltage configuration values across 12C bus 222 into registers 214 and 216, respectively. Registers 214 and 216 then configure voltage regulators V_{memory} 204 and V_{I/O} 206 to supply a memory voltage and an I/O voltage to CPU chip 110 and JTAG controller 201 as well as other components on CPU board 104 that require these voltages. The memory voltage is used by computer system 100 to power a memory bus and/or memory boards within computer system 100. The I/O voltage is used to supply I/O buffers within CPU chip 110 and JTAG controller 201 to drive I/O pins.

Next, values for a selected set of I/O pins from CPU chip 110 are clocked in VID register 220. These values specify an initial core voltage for CPU chip 110. System controller 109 determines the initial core voltage by reading VID register 220, and applies the initial core voltage to CPU chip 110 by writing a value to register 218 which causes voltage regulator V_{core} 120 to supply an initial core voltage to CPU chip 110.

System controller 109 then communicates with JTAG controller 201 through service bus 224. JTAG controller 201 performs a boundary of CPU chip 110 scan through TDO and TDI signal lines to retrieve a JTAG identifier from CPU chip 110. This JTAG identifier identifies the type and version for CPU chip 110. Next, system controller 109 looks up the optimal core voltage for CPU chip 10, and writes a value to register 218 which causes voltage regulator Vcore 120 to supply the optimal core voltage to CPU chip 110. This process is described in more detail below with reference to FIG. 2.

Voltage Setting Process

FIG. 3 presents a flow chart illustrating the process of setting a core voltage in accordance with an embodiment of the present invention. This process takes place during initialization of computer system 100, which typically occurs immediately after the system is powered on. First, system controller 109 is initialized (operation 302). Next, system controller 109 applies a pre-specified memory voltage and a pre-specified I/O voltage to CPU chip 110 by writing to registers 214 and 216, respectively (operation 304). This I/O voltage enables I/O pins on CPU chip 110 to operate.

System controller 109 then reads values from voltage identification pins on CPU chip 110 by reading register 220 (operation 306). These values specify an initial core voltage for CPU chip 110. In one embodiment of the present invention, pin limitation problems cause the number of voltage identification pins to be too small to accurately specify the range of possible core voltages for the CPU. In this embodiment, the initial core voltage is specified only approximately through the small number of voltage identification pins, which leads to a less-accurate initial voltage. However, note that the optimal core voltage can be specified to a higher precision during the a subsequent lookup process in operation 312 below.

System controller 109 then writes to register 218 which causes voltage regulator V_{core} 120 to supply the initial core voltage to CPU chip 110 (operation 308). In one embodiment of the present invention, this involves first programming voltage regulator V_{core} 120 to produce the initial core voltage, and then activating voltage regulator V_{core} 120 to supply the initial core voltage to the CPU chip 110.

After the initial core voltage is applied to CPU chip 110, system controller 109 reads an identifier from CPU chip 110 (operation 310). In one embodiment of the present invention, this involves using JTAG controller 210 to read a JTAG identifier from CPU chip 110.

System controller then uses the identifier to lookup an optimal voltage for CPU chip 110 (operation 312). This lookup can be performed in a table of optimal voltage values maintained within system controller 109. System controller subsequently applies this optimal core voltage to CPU chip 110 by writing to register 218 (operation 314). In one embodiment of the present invention, the initial core voltage differs from the optimal core voltage because the initial core voltage is determined through estimation before the CPU chip is manufactured, whereas the optimal core voltage is determined empirically after the CPU chip is manufactured.

Computer system 100 then proceeds with its initialization sequence by running a Power-On Self-Test (POST) sequence (operation 316).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for setting a core voltage for a central processing unit (CPU) contained within a CPU chip in a computer system, comprising:
applying an I/O voltage to the CPU chip, thereby enabling I/O buffers within the CPU chip to drive I/O pins on the CPU chip;
reading a selected set of I/O pins on the CPU chip, wherein the selected set of I/O pins specify an initial core voltage for the CPU;
applying the initial core voltage to the CPU chip to enable the CPU to operate;
when the CPU is able to operate, reading a CPU identifier from the CPU chip;
using the CPU identifier to lookup an optimal core voltage for the CPU; and
applying the optimal core voltage to the CPU chip.

2. The method of claim 1, wherein the initial core voltage may differ from the optimal core voltage because the initial core voltage is determined through estimation before the CPU chip is manufactured, whereas the optimal core voltage is determined empirically after the CPU chip is manufactured.

3. The method of claim 1, wherein the selected set of I/O pins is too small to accurately specify the range of possible core voltages for the CPU.

4. The method of claim 1, wherein reading the CPU identifier involves performing a Joint Test Action Group (JTAG) boundary scan of the CPU chip to read a JTAG identifier for the CPU chip.

5. The method of claim 1, wherein the method is performed by a system controller which is responsible for initializing voltages for CPUs within the computer system.

6. The method of claim 1, wherein the method is performed as part of an initial boot sequence for the computer system.

7. The method of claim 1, wherein applying the initial core voltage to the CPU involves:
programming a voltage regulator for the CPU chip to produce the initial core voltage; and
activating the voltage regulator to supply the initial core voltage to the CPU chip.

8. An apparatus that sets a core voltage for a central processing unit (CPU) within a CPU chip in a computer system, comprising:
a voltage initialization mechanism that is configured to,
apply an I/O voltage to the CPU chip, thereby enabling I/O buffers within the CPU chip to drive I/O pins on the CPU chip,
read a selected set of I/O pins on the CPU chip, wherein the selected set of I/O pins specify an initial core voltage for the CPU, and to
apply the initial core voltage to the CPU chip to enable the CPU to operate; and
a voltage optimizing mechanism that is configured to,
read a CPU identifier from the CPU chip,
use the CPU identifier to lookup an optimal core voltage for the CPU, and to
apply the optimal core voltage to the CPU chip.

9. The apparatus of claim 8, wherein the initial core voltage may differ from the optimal core voltage because the initial core voltage is determined through estimation before the CPU chip is manufactured, whereas the optimal core voltage is determined empirically after the CPU chip is manufactured.

10. The apparatus of claim 8, wherein the selected set of I/O pins is too small to accurately specify the range of possible core voltages for the CPU.

11. The apparatus of claim 8, wherein while reading the CPU identifier, the voltage optimizing mechanism is configured perform a Joint Test Action Group (JTAG) boundary scan of the CPU chip to read a JTAG identifier for the CPU chip.

12. The apparatus of claim 8, wherein the apparatus is implemented within a system controller which is responsible for initializing voltages for CPUs within the computer system.

13. The apparatus of claim 8, wherein the apparatus is activated during an initial boot sequence for the computer system.

14. The apparatus of claim 8, wherein while applying the initial core voltage to the CPU, the voltage initialization mechanism is configured to:
program a voltage regulator for the CPU chip to produce the initial core voltage; and to
activate the voltage regulator to supply the initial core voltage to the CPU chip.

15. A computer system that is configured to set a core voltage for a central processing unit (CPU), comprising:
a CPU located within a CPU chip;
a memory;
a power supply that supplies voltage to the CPU chip and to the memory;
a voltage initialization mechanism that is configured to,
apply an I/O voltage to the CPU chip, thereby enabling I/O buffers within the CPU chip to drive I/O pins on the CPU chip,
read a selected set of I/O pins on the CPU chip, wherein the selected set of I/O pins specify an initial core voltage for the CPU, and to
apply the initial core voltage to the CPU chip to enable the CPU to operate; and
a voltage optimizing mechanism that is configured to,
read a CPU identifier from the CPU chip,
use the CPU identifier to lookup an optimal core voltage for the CPU, and to
apply the optimal core voltage to the CPU chip.

16. The computer system of claim 15, wherein the initial core voltage may differ from the optimal core voltage because the initial core voltage is determined through estimation before the CPU chip is manufactured, whereas the optimal core voltage is determined empirically after the CPU chip is manufactured.

17. The computer system of claim 15, wherein the selected set of I/O pins is too small to accurately specify the range of possible core voltages for the CPU.

18. The computer system of claim 15, wherein while reading the CPU identifier, the voltage optimizing mechanism is configured perform a Joint Test Action Group (JTAG) boundary scan of the CPU chip to read a JTAG identifier for the CPU chip.

19. The computer system of claim 15, wherein the voltage initialization mechanism and the voltage optimizing mechanism are implemented within a system controller that is responsible for initializing voltages for CPUs within the computer system.

20. The computer system of claim 15, wherein the voltage initialization mechanism and the voltage optimizing mechanism are activated during an initial boot sequence for the computer system.

21. The computer system of claim 15, wherein while applying the initial core voltage to the CPU, the voltage initialization mechanism is configured to:
program a voltage regulator for the CPU chip to produce the initial core voltage; and to
activate the voltage regulator to supply the initial core voltage to the CPU chip.
